(19) United States
(12) Patent Application Publication
(10) Pub. No.: US 2025/0380047 A1
(43) Pub. Date: Dec. 11, 2025

(54) METHOD FOR DISPLAYING THUMBNAIL DURING SHOOTING AND ELECTRONIC DEVICE

(71) Applicant: Honor Device Co., Ltd., Shenzhen (CN)

(72) Inventor: Jirun XU, Shenzhen (CN)

(73) Assignee: Honor Device Co., Ltd., Shenzhen (CN)

(21) Appl. No.: 18/838,034

(22) PCT Filed: May 19, 2023
(86) PCT No.: PCT/CN2023/095202

§ 371 Date: Feb. 7, 2025

(30) Foreign Application Priority Data
Jul. 5, 2022 (CN) 202210784093.6

(51) Int. Cl. H04N 23/63; G06F 3/0484; G06F 3/0488; H04N 23/62

(52) U.S. Cl. CPC H04N 23/632; H04N 23/62; G06F 3/0484; G06F 3/0488

(57) ABSTRACT

Embodiments of this application provide a method for displaying a thumbnail during shooting and an electronic device. In the method, a terminal generates a first thumbnail in a shooting interface of the terminal when a user presses a shooting control in the shooting interface but does not lift a hand, and the terminal displays the first thumbnail in a thumbnail display region of the shooting interface when the user lifts the hand.

### CROSS-REFERENCE TO RELATED APPLICATIONS

This application is a national stage of International Application No. PCT/CN2023/095202, filed on May 19, 2023, which claims priority to Chinese Patent Application No. 202210784093.6, filed on Jul. 5, 2022. The disclosures of both of the aforementioned applications are hereby incorporated by reference in their entireties.

### TECHNICAL FIELD

Embodiments of this application relate to the field of shooting technologies, and in particular to a method for displaying a thumbnail during shooting and an electronic device.

### BACKGROUND

With improvement of hardware configurations of terminals, more users choose to use the terminals to record wonderful moments in life. The terminal has a photo instant display function. To be specific, a photo taken by the terminal is instantly displayed in a form of a thumbnail in a specific region of a screen of the terminal, to help the user determine that a shooting operation is completed. The user may preview the taken photo by tapping the thumbnail.

At present, long duration is taken from a time at which the user triggers the terminal to perform shooting to a time at which the terminal displays the thumbnail.

### SUMMARY

Embodiments of this application provide a method for displaying a thumbnail during shooting and an electronic device, to reduce duration taken from a time at which a user taps a shooting control to a time at which a thumbnail is displayed, enabling the user to quickly view the thumbnail during shooting, and improving a shooting speed of the terminal.

An embodiment of this application provides a method for displaying a thumbnail during shooting. An execution entity that performs the method may be a terminal or a chip in a terminal. The following uses a terminal as an example for description. In the method, a terminal generates a first thumbnail in a shooting interface of the terminal when a user presses a shooting control in the shooting interface but does not lift a hand, and the terminal displays the first thumbnail in a thumbnail display region of the shooting interface when the user lifts the hand.

In conventional technologies, a terminal may perform an operation of generating and displaying a thumbnail after a user presses a shooting control in a shooting interface and lifts a hand. Therefore, long duration is taken, and a shooting speed of the terminal perceived by the user is slow. In this application, the operation of generating the first thumbnail is shifted before the operations that “the user presses the shooting control and the user lifts the hand”. Therefore, only the operation of displaying the first thumbnail needs to be performed when the user lifts the hand, without performing, with long duration, an operation of generating the first thumbnail. This reduces duration taken from a time at which the user taps the shooting control to a time at which the first thumbnail is displayed, to enable the user to quickly view the first thumbnail, and improve the shooting speed of the terminal.

The following describes a process in which the terminal generates the thumbnail and displays the thumbnail.

The terminal includes: a camera application, a thumbnail processing module, and an image processing module. When the user presses the shooting control but does not lift the hand, the camera application controls the thumbnail processing module to generate the first thumbnail. For example, the camera application sends a thumbnail generating indication to the thumbnail processing module, to trigger the thumbnail processing module to generate the first thumbnail. After generating the first thumbnail, the thumbnail processing module sends the first thumbnail to the image processing module. The image processing module feeds back the first thumbnail to the camera application when the user lifts the hand; and the camera application controls the terminal to display the first thumbnail in the thumbnail display region.

In a possible implementation, the terminal further includes: a request processing module, a decision-making engine, and a frame selection module. When the user presses the shooting control but does not lift the hand, sending, by the camera application, a first event to the request processing module, where the first event indicates to generate the thumbnail. The request processing module sends a thumbnail generation request to the decision-making engine in response to the first event, the decision-making engine sends the frame sequence information to the frame selection module in response to the thumbnail generation request. In an embodiment, frame sequence information indicates a type of a photo in a photo frame sequence, and a frame quantity (that is, a quantity of photos in the photo frame sequence).

The frame selection module obtains the photo frame sequence based on the frame sequence information, where the photo frame sequence includes at least two photos. It should be understood that photos in the photo frame sequence are RAW images. In an embodiment, the frame selection module may obtain a photo frame sequence from a camera lens (a sensor) of the terminal.

The frame selection module selects a target frame from the photo frame sequence, and sends the target frame to the thumbnail processing module. The thumbnail processing module generates the first thumbnail based on the target frame. In an embodiment, the thumbnail processing module may convert the target frame (a RAW image) to a YUV format, and then convert the target frame in the YUV format to an RGB format, to obtain the first thumbnail.

In a possible implementation, the terminal further includes: an event processing interface. The camera application sends a first event to the request processing module via the event processing interface.

In a possible implementation, the frame selection module may take a photo with highest charity in the photo frame sequence as the target frame, that is, the target frame is the photo with the highest resolution in the photo frame sequence. In a possible implementation, the frame selection module selects the target frame from the photo frame sequence based on a shooting parameter of each photo in the photo frame sequence. The shooting parameter may include but is not limited to: a focus value (a focus value) and photosensitivity ISO.

The above describes the process of generating the first thumbnail of the terminal, and the following describes a process of displaying the first thumbnail of the terminal.

In a possible implementation, the terminal further includes: a shooting decision-making module. When the user lifts the hand, the camera application sends a second event to the shooting decision-making module, where the second event indicates to display the thumbnail. The shooting decision-making module sends a thumbnail feedback indication to the image processing module in response to the second event. The image processing module feeds back the first thumbnail to the camera application in response to the thumbnail feedback indication. In this way, the camera application controls the terminal to display the first thumbnail in the thumbnail display region. In a possible implementation, the camera application sends the second event to the shooting decision-making module via the event processing interface.

In a possible implementation, the terminal may perform an accidental touch prevention operation. An operation performed by the user in the shooting interface is a continuous shooting operation or a sliding operation. The continuous shooting operation or the sliding operation includes an operation that the user presses the shooting control. Therefore, the terminal can perform the operation of generating the first thumbnail. However, the continuous shooting operation or the sliding operation is not an operation that the user taps the shooting control to take a photo. Therefore, to avoid misoperation by the user, a response may be performed accurately. If an operation performed by the user in the shooting interface is the continuous shooting operation or the sliding operation, the camera application sends a canceling instruction to the request processing module, where the canceling instruction indicates to cancel generation of the thumbnail.

The request processing module sends a thumbnail canceling request to the decision-making engine. When the decision-making engine sends the frame sequence information to the frame selection module, the decision-making engine sends a frame selection stopping request to the frame selection module. When the frame selection module sends the target frame to the thumbnail processing module, the frame selection module sends a processing stopping request to the thumbnail processing module. When the thumbnail processing module sends the first thumbnail to the image processing module, the thumbnail processing module sends a stopping request to the image processing module. When the image processing module receives the thumbnail feedback indication from the shooting decision-making module, the image processing module does not feed back the first thumbnail to the camera application.

In this embodiment of this application, when the operation performed by the user in the shooting interface is the continuous shooting operation or the sliding operation, the terminal may cancel the operation of generating the thumbnail or the operation of generating the thumbnail. However, the image processing module does not feed back the first thumbnail to the camera application, that is, does not perform the operation of displaying the thumbnail, to implement a precise response.

The terminal generates the first thumbnail based on the target frame, so that a speed of the terminal in displaying the thumbnail is improved, to enable the user to perceive that the shooting speed of the terminal is fast. In a possible implementation, the terminal may further improve quality of the thumbnail.

In this implementation, the terminal further includes: a gallery application. After the image processing module feeds back the first thumbnail to the camera application, the camera application sends the first thumbnail to the gallery application; and the gallery application stores the first thumbnail.

After receiving the first thumbnail from the thumbnail processing module, the image processing module obtains the photo frame sequence from the frame selection module, and generates a second thumbnail based on the photo frame sequence. For example, the image processing module may fuse a region having the best quality in each photo in the photo frame sequence, to obtain a fused RAW image with high charity, and generate the second thumbnail based on the fused RAW image. In an embodiment, quality (charity) of the second thumbnail is higher than quality (charity) of the first thumbnail. In this embodiment, the terminal may obtain a thumbnail with higher charity.

In this way, the image processing module sends the second thumbnail to the gallery application, and the gallery application replaces the first thumbnail with the second thumbnail. In this implementation, when the terminal displays the shooting interface, the camera application obtains the second thumbnail from the gallery application, and the camera application controls the terminal to display the second thumbnail in the thumbnail display region.

In this implementation, the terminal may display a second thumbnail with higher charity in the thumbnail display region, to enable the user to view more clearly. This improves user experience.

In an embodiment, modules described in the first aspect may be integrated with each other, to perform steps of the integrated modules.

According to a second aspect, an embodiment of this application provides an electronic device. The electronic device may include: a processor and a memory. The memory is configured to store computer-executable program code. The program code includes instructions. When the processor executes the instructions, the instructions enable the electronic device to perform the method according to the first aspect.

According to a third aspect, an embodiment of this application provides a computer program product including instructions. When the computer program product is run on a computer, the computer is enabled to perform the method according to the first aspect.

According to a fourth aspect, an embodiment of this application provides a computer-readable storage medium. The computer-readable storage medium stores instructions. When the instructions are run on a computer, the computer is enabled to perform the method according to the first aspect.

For beneficial effects of the possible implementations of the second aspect to the fourth aspect, reference may be made to the beneficial effects brought by the first aspect. This is not described herein again.

### BRIEF DESCRIPTION OF DRAWINGS

FIG. 1 is a schematic diagram of a terminal displaying a thumbnail;

FIG. 2 is a block diagram of a structure of a terminal according to an embodiment of this application;

FIG. 3 is a schematic flowchart of a terminal shooting a photo and displaying a thumbnail according to an embodiment of this application;

FIG. 4 is a schematic diagram of a scenario in which a terminal displays a thumbnail according to an embodiment of this application;

FIG. 5 is a block diagram of another structure of a terminal according to an embodiment of this application;

FIG. 6A and FIG. 6B are schematic flowcharts of a method for displaying a thumbnail during shooting according to an embodiment of this application;

FIG. 7 is a schematic diagram of another scenario in which a terminal displays a thumbnail according to an embodiment of this application;

FIG. 8A and FIG. 8B are schematic flowcharts of a method for displaying a thumbnail during shooting according to another embodiment of this application;

FIG. 9A is a schematic diagram of an operation performed on a shooting control by a user;

FIG. 9B is a schematic diagram of another operation performed on a shooting control by a user;

FIG. 10A and FIG. 10B are schematic flowcharts of a method for displaying a thumbnail during shooting according to another embodiment of this application; and

FIG. 11 is a schematic diagram of a structure of an electronic device according to an embodiment of this application.

### DESCRIPTION OF EMBODIMENTS

A terminal in embodiments of this application may be referred to as user equipment. For example, the terminal may be a mobile phone, a portable Android® device (PAD), a personal digital assistant (PDA), a handheld device having a wireless communication function, a computing device, an on-board device or a wearable device, a virtual reality (VR) terminal device, an augmented reality (AR) terminal device, a wireless terminal in industrial control, a terminal in smart home, and the like. A form of the terminal is not specifically limited in embodiments of this application. In embodiments of this application, an example in which the terminal is a mobile phone is used for description.

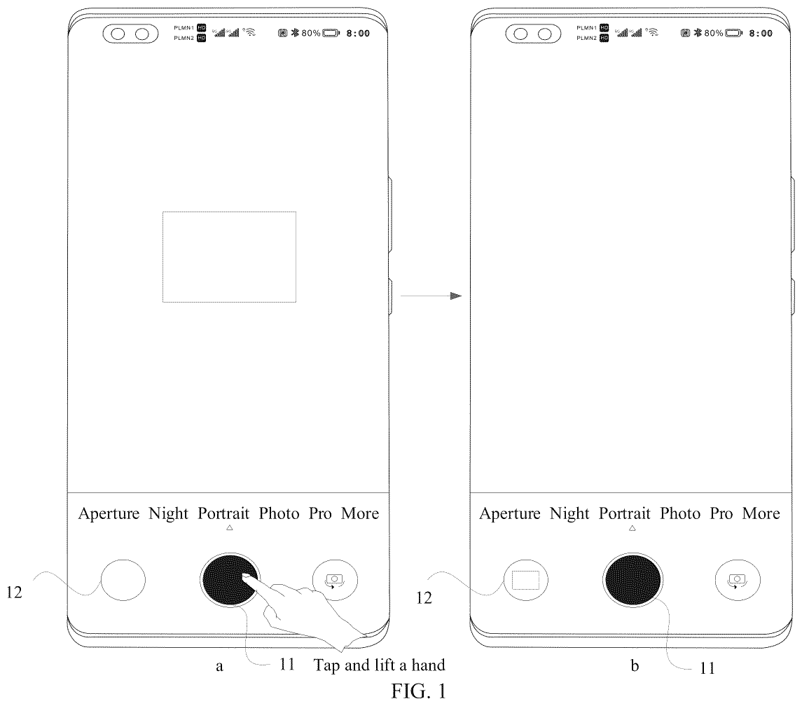

FIG. 1 is a schematic diagram of a terminal displaying a thumbnail. A in FIG. 1 shows a shooting interface of a camera application in a mobile phone. The shooting interface shows a shooting control 11 and a thumbnail display region 12. It should be understood that, in this embodiment of this application, not all controls on the shooting interface are shown, and only controls in embodiments of this application are shown. A user aligns a camera to an object (for example, a rectangle) and taps the shooting control 11, to trigger the mobile phone to take a photo and obtain a rectangular photo. Refer to B in FIG. 1. After the mobile phone takes a photo, a thumbnail of the rectangular photo may be displayed in the thumbnail display region 12.

An imaging speed of the mobile phone is one of important indicators for evaluating shooting of the mobile phone, and one of the indicators is performance of shot2see. Long duration taken from a time at which the user taps the shooting control 11 to a time at which the thumbnail is displayed in the thumbnail display region 12 may represent the performance of shot2see of the mobile phone. If the duration is shorter, the performance of shot2see is better. If the long duration is taken, the performance of shot2see is poorer. The duration taken from the time at which the user taps the shooting control 11 to the time at which the thumbnail is displayed in the thumbnail display region 12 is a shooting speed that may be intuitively felt by the user.

At present, long duration is taken from the time at which the user taps the shooting control 11 to the time at which the thumbnail is displayed in the thumbnail display region 12. Therefore, the user feels that the shooting speed is slow and user experience is poor.

To find out a reason that the performance of shot2see of the terminal is poor (that is, long duration is taken from the time at which the user taps the shooting control 11 to the time at which the thumbnail is displayed in the thumbnail display region 12), the following analyzes a process in which the terminal takes a photo and displays a thumbnail on the terminal, to find out a reason that the shooting speed is slow.

Before a process in which the terminal performs shooting and displays the thumbnail on the terminal is described, a software architecture of the terminal is first described.

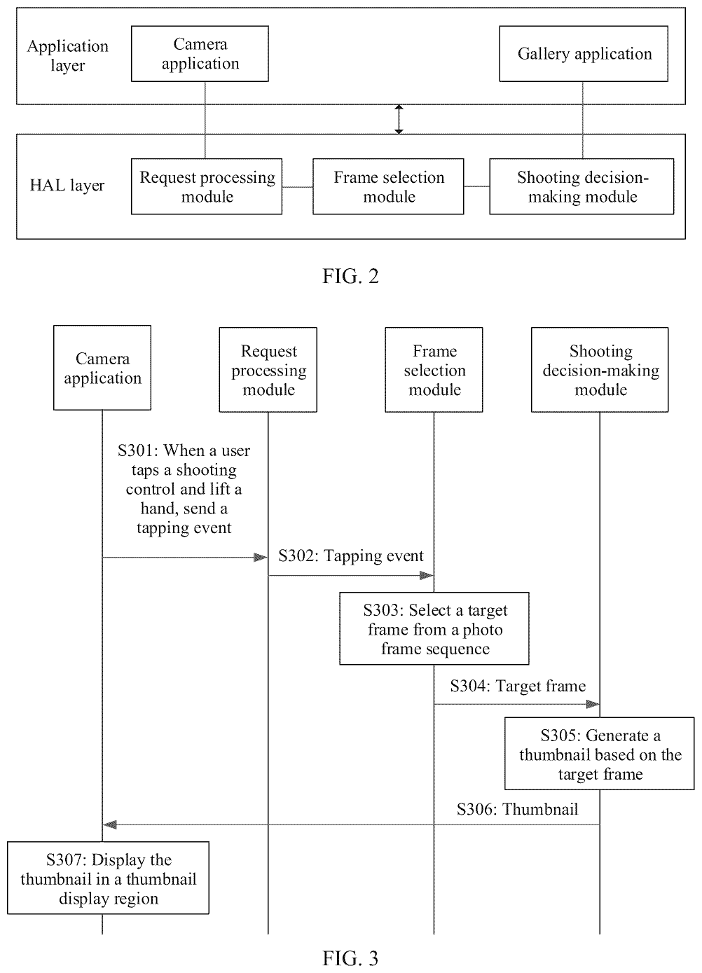

FIG. 2 is a block diagram of a structure of a terminal according to an embodiment of this application. A software system of the terminal may use a layered architecture, an event-driven architecture, a microkernel architecture, a micro service architecture, or a cloud architecture. In the embodiments of this application, an Android® system of the layered architecture is used as an example to illustrate a software structure of the terminal. In the layered architecture, the software system of the terminal is divided into several layers, each layer has a clear role and task, and the layers communicate with each other via a software interface.

In an embodiment, an Android® system is divided into five layers: an application layer, an application framework layer, an Android® runtime, a system library, a hardware abstract layer (HAL), and a kernel layer. FIG. 2 shows the application layer and the hardware abstraction layer in embodiments of this application. The following describes the application layer and the hardware abstraction layer. For functions of other layers, refer to related description in an existing Android® system.

The application layer may include an application package. For example, the application layer may include application packages such as Camera, Gallery, Calendar, Phone, Map, Navigation, Bluetooth, Music, Videos, and Messages. As shown in FIG. 2, a camera application and a gallery application in embodiments of this application are shown in the application layer.

The hardware abstract layer may include a plurality of library modules, such as a camera lens library module, and a motor library module. The Android® system can load corresponding library modules for device hardware, and then realize the purpose of accessing the device hardware by the application framework layer. The device hardware may include, for example, a motor, and a camera lens.

In an embodiment, the hardware abstraction layer may further include: a request processing module, a frame selection module, and a shooting decision-making module. The request processing module is configured to process an event from the camera application. The frame selection module is configured to select a frame from a plurality of frames of photos captured by a camera (a camera lens), to generate a thumbnail. The shooting decision-making module is configured to generate a thumbnail based on a frame of photo selected by the frame selection module, to enable the terminal to display the thumbnail.

Based on the structure of the terminal shown in FIG. 2, the following describes a process in which the terminal takes a photo and displays a thumbnail with reference to FIG. 3.

S301: When a user taps a shooting control and lifts a hand, the camera application sends a tap event to the request processing module.

The tap event indicates that the user taps the shooting control and lifts the hand. In an embodiment, the tap event triggers the terminal to take a photo and display a thumbnail in a thumbnail display region.

S302: The request processing module synchronizes the tap event to the frame selection module.

S303: The frame selection module selects a target frame from a photo frame sequence.

The terminal takes the photo based on a shooting parameter, to obtain the photo frame sequence. The photo frame sequence may include a plurality of photos, all of which are RAW (raw image file) photos. It should be understood that a quantity of photos in the photo frame sequence may be preset, for example, the quantity of photos in the photo frame sequence may be 8, that is, the photo frame sequence includes eight frames of photos.

In an embodiment, the frame selection module may select a frame of photo with highest charity from the photo frame sequence, and take the frame of photo with the highest charity as a target frame.

S304: The frame selection module sends the target frame to the shooting decision-making module.

S305: The shooting decision-making module generates a thumbnail based on the target frame.

In an embodiment, the shooting decision-making module may convert the target frame to a YUV format, and then convert the target frame in the YUV format to an RGB format, to obtain the thumbnail.

S306: The shooting decision-making module feeds back the thumbnail to the camera application.

S307: The camera application displays the thumbnail in a thumbnail display region.

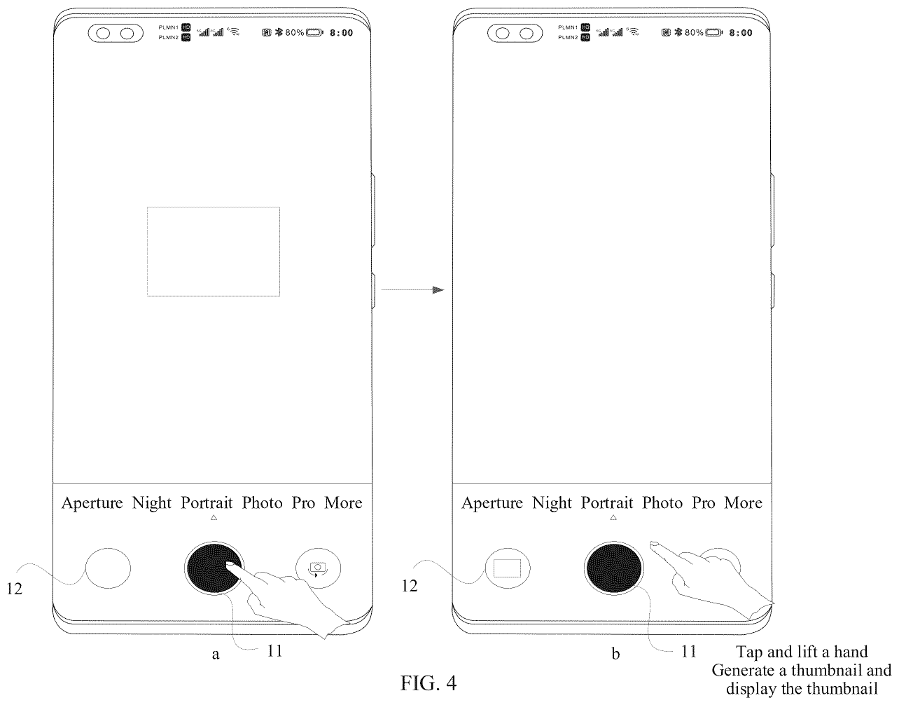

Refer to FIG. 4. When the user presses a shooting control 11 and lifts the hand, the terminal may be triggered to perform S301 to S307, to enable the terminal to display the thumbnail in the thumbnail display region. The duration taken from the time at which the user taps the shooting control 11 to the time at which the thumbnail is displayed in a thumbnail display region 12 is the process in which the terminal performs S301 to S307, about 1 s.

Because the terminal performs S301 to S307 when the user taps the shooting control and lifts the hand, the duration taken from a time at which the user taps the shooting control 11 to from a time at which the thumbnail is displayed is the process in which the terminal performs S301 to S307. In this embodiment of this application, to reduce duration of displaying the thumbnail after the user taps the shooting control 11, a pipeline (may be a private pipeline) is disposed in the terminal. Through the pipeline, the thumbnail is generated when the user presses the shooting control and displays the thumbnail when the user lifts the hand. In this way, the process of generating the thumbnail is shifted forward, and the terminal only needs to perform the step of displaying the thumbnail when the user lifts the hand, so that the user can quickly view the thumbnail, and perceive that a shooting speed of the terminal is fast. It should be understood that the user presses the shooting control and lifts the hand may be referred to as a tap on the shooting control.

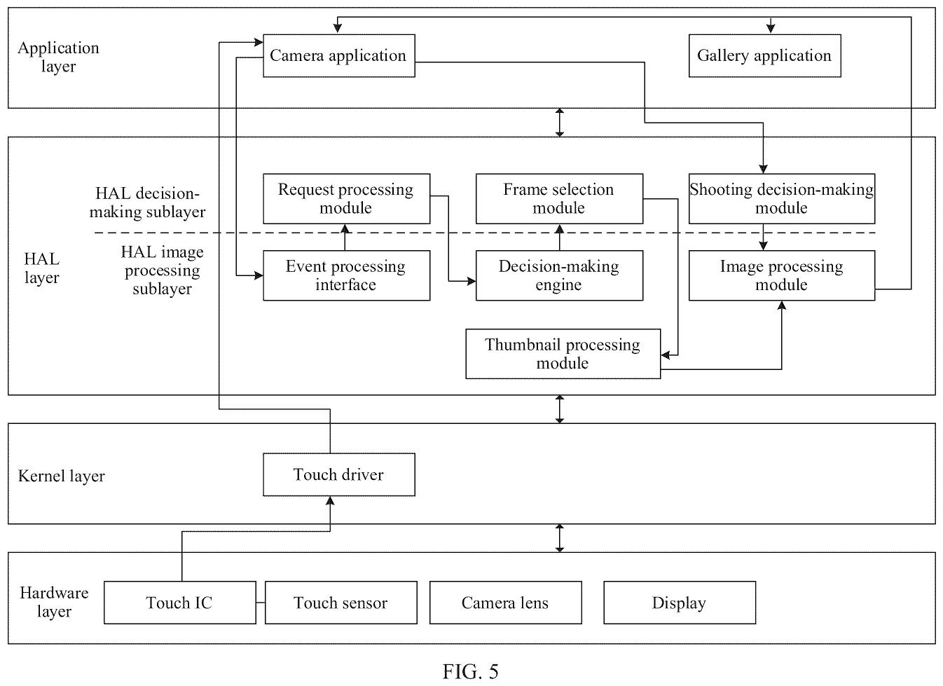

Before proceeding to the method for displaying a thumbnail during shooting provided in this embodiment of this application, a structure of the terminal is first described. FIG. 5 is a block diagram of another structure of a terminal according to an embodiment of this application. For an application layer, a hardware abstraction layer, and a request processing module, a frame selection module, and a shooting decision-making module in the hardware abstraction layer in FIG. 5, refer to related description in FIG. 2.

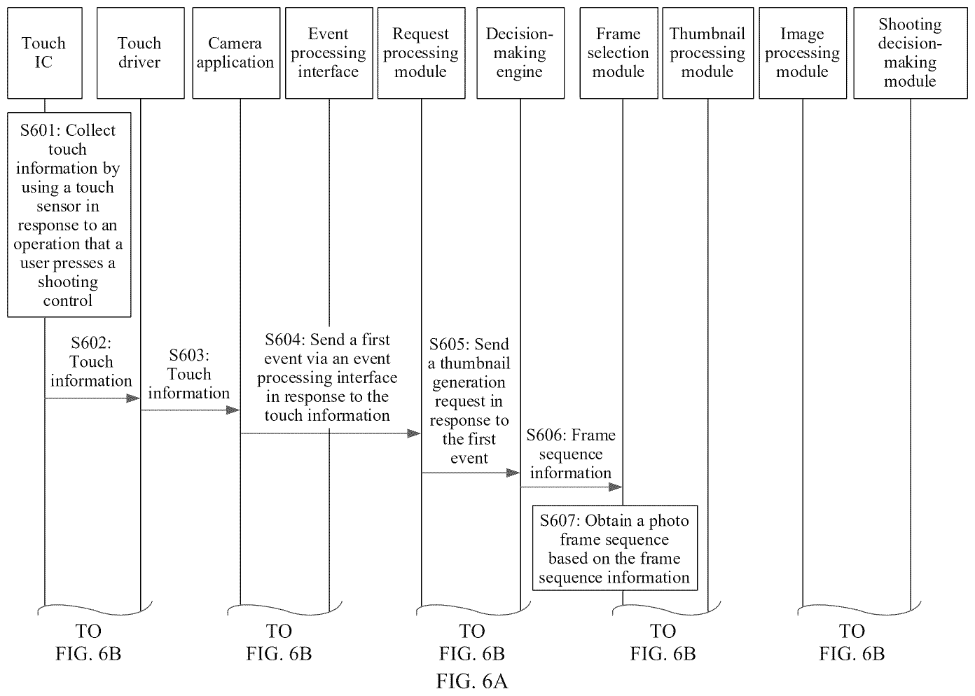

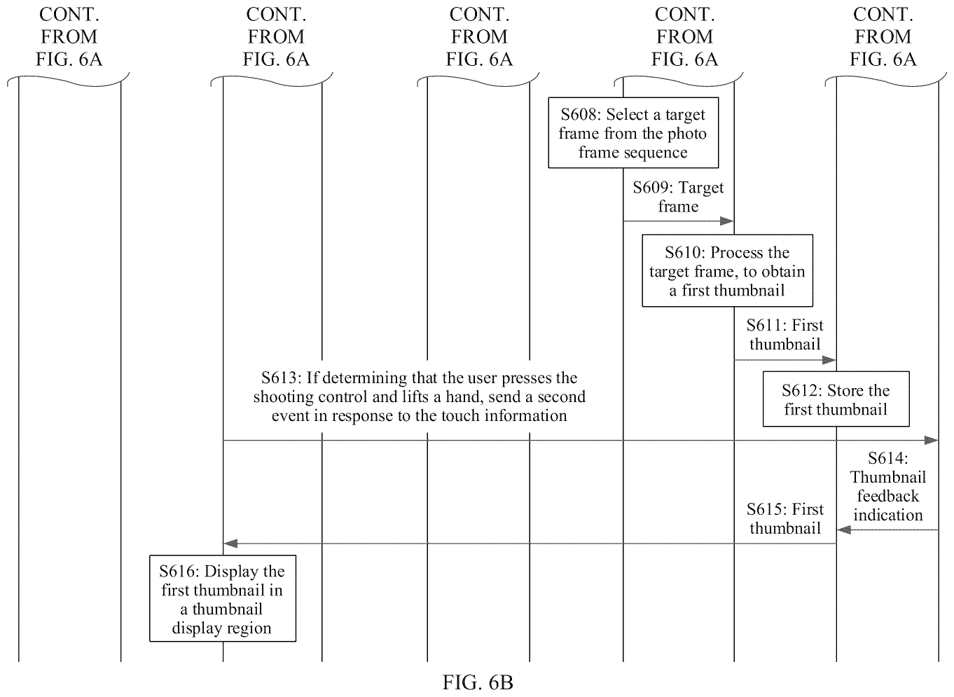

A difference from FIG. 2 is that, in an embodiment, as shown in FIG. 5, the hardware abstraction layer may further include: an event processing interface, a decision-making engine, a thumbnail processing module, and an image processing module. For functions of modules in the hardware abstraction layer, refer to related description in FIG. 6A and FIG. 6B.

In an embodiment, the hardware abstraction layer may include: a HAL image processing sublayer and a HAL decision-making sublayer. The event processing interface, the decision-making engine, the thumbnail processing module, and the image processing module may be disposed in the HAL image processing sublayer. The request processing module, the frame selection module, and the shooting decision-making module may be disposed in the HAL decision-making sublayer.

In an embodiment, the event processing interface, the decision-making engine, the thumbnail processing module, and the image processing module may be referred to as nodes in the pipeline disposed in the terminal. The nodes perform different steps, and the nodes cooperate with each other to complete generation of the thumbnail.

In an embodiment, FIG. 5 shows a kernel layer. The kernel layer includes at least a driver for hardware, and the driver is configured to drive the hardware to work. For example, the kernel layer may include a touch driver, a display driver, and the like, and is not limited in this embodiment of this application. The touch driver is configured to display a touch function of the terminal, and the display driver is configured to implement a display function of the terminal. It should be understood that FIG. 5 shows the touch driver in embodiments of this application.

Based on a terminal software layer architecture, as shown in FIG. 5, the terminal further includes a hardware layer. The hardware layer may include a hardware device. The hardware device, for example, a touch panel, a display panel (may be referred to as a display or a screen), a Bluetooth chip, an accelerometer sensor, or a gyroscope sensor, is not described herein. FIG. 5 shows the touch panel (a touch integrated circuit (IC) and a touch sensor), the camera lens, and the display in embodiments of this application.

The camera lens is configured to shoot (or take a photo), to obtain a photo stream. In an embodiment, the photo stream may be referred to as a shooting stream.

In an embodiment, the touch panel may include: a touch sensor (a TP sensor) and a touch integrated circuit (IC) chip. The touch driver is configured to drive the touch IC to work.

Layering of a software structure of the terminal is not limited in embodiments of this application. FIG. 5 shows an example. Modules included in layers shown in FIG. 5 are modules in embodiments of this application. The modules in the layers do not constitute a limitation to the structure of the terminal, and the layers (illustrated in the example) deployed in the modules do not constitute a limitation to the structure of the terminal. In an embodiment, modules shown in FIG. 5 may be deployed separately, or several modules may be deployed together, and division of the modules in FIG. 5 is an example. In an embodiment, names of the modules shown in FIG. 5 are examples for description.

Based on the structure of the terminal shown in FIG. 5, the following describes the method for displaying a thumbnail during shooting in embodiments of this application with reference to specific embodiments. The following several embodiments may be mutually combined, and same or similar concepts or processes may not be repeatedly described in some embodiments.

FIG. 6A and FIG. 6B are schematic flowcharts of a method for displaying a thumbnail during shooting according to an embodiment of this application. As shown in FIG. 6A and FIG. 6B, the method for displaying a thumbnail during shooting according to an embodiment of this application may include the following steps.

S601: A touch IC collects touch information by using a touch sensor in response to an operation that a user presses a shooting control.

The operation that the user presses the shooting control may be understood as that the user presses the shooting control and does not lift a hand.

It should be understood that variation of a capacitance sampling value of the touch sensor changes when a finger of the user approaches a screen. Accordingly, the touch IC can obtain the variation of the capacitance sampling value of the touch sensor in real time.

In an embodiment, when the finger of the user gradually approaches the screen, the touch IC detects that the variation of the capacitance sampling value of the touch sensor gradually increases. When the touch IC detects that the variation of the capacitance sampling value of the touch sensor increases to preset variation of the capacitance sampling value, the touch IC may determine that the finger of the user is in contact with the screen. In other words, when the touch IC detects that the variation of the capacitance sampling value of the touch sensor reaches the preset variation of the capacitance sampling value and determines that the finger of the user is in contact with the screen, the touch IC obtains a position of the finger of the user on the screen based on the variation of the capacitance sampling value of the touch sensor. For example, when the touch IC responds to a case in which the variation of the capacitance sampling value of the touch sensor is greater than or equal to 100% (that is, the finger of the user is in contact with the screen), the touch IC obtains the position of the finger of the user on the screen.

In an embodiment, the touch information may include: a touch position.

In an embodiment, if a terminal supports an operation of a stylus, the touch IC may further determine, based on an area of a change of the variation of the capacitance sampling value of the touch sensor, whether the stylus or the finger of the user approaches the screen. An area of a change of the variation of the capacitance sampling value of the touch sensor in a case of the finger of the user is larger than an area of a change of the variation of the capacitance sampling value of the touch sensor in a case of stylus. If the area of the change of the variation of the capacitance sampling value of the touch sensor is larger than a preset area, the touch IC determines that the finger of the user approaches the screen. Therefore, it may be determined that a touch type is a user type. If the touch IC determines that the stylus approaches the screen, it is determined that the touch type is a stylus type. In the following embodiments, an example in which the touch type is the user type is used for description.

In this embodiment, the touch information of the user may include: the touch position, and a user type. The user type indicates that it is the finger of the user that approaches the screen, not the stylus.

In an embodiment, when determining that the variation of the capacitance sampling value of the touch sensor increases to the preset variation of the capacitance sampling value, the touch IC may report the variation of the capacitance sampling value of the touch sensor and the user type to a touch driver, and the touch driver determines the touch position based on the variation of the capacitance sampling value of the touch sensor, and reports the touch position.

S602: The touch IC sends the touch information to the touch driver.

S603: The touch driver sends the touch information to a camera application.

S604: The camera application sends a first event to a request processing module via an event processing interface in response to the touch information.

The camera application receives the touch information, and may determine, based on the touch position in the touch information and layout of a camera interface, that the user presses the shooting control. The camera application may generate the first event in response to a case in which the user presses the shooting control. The first event may be referred to as a clickdown event, and indicates that the user presses the shooting control.

In an embodiment, the first event is used to trigger generation of a thumbnail.

S605: The request processing module sends a thumbnail generation request to a decision-making engine in response to the first event.

The thumbnail generation request indicates the decision-making engine to generate the thumbnail.

S606: The decision-making engine sends frame sequence information to a frame selection module in response to the thumbnail generation request.

The frame sequence information indicates a type of a photo frame and a frame quantity N. For example, the frame sequence information may include: a quantity of frames of photos in a zsl frame type, and/or a quantity of frames of photos in a non zsl frame type.

S607: The frame selection module obtains a photo frame sequence based on the frame sequence information.

It should be understood that the camera application may start a camera lens when the user opens the camera application. The camera lens may capture a photo stream by photosensing. The frame selection module may select, based on the frame sequence information, N frames of photos in a corresponding type from the photo stream in response to the frame sequence information synchronized by the decision-making engine, to obtain the photo frame sequence. For example, the photo frame sequence may include eight frames of photos, all of which are RAW images.

S608: The frame selection module selects a target frame from the photo frame sequence.

In an embodiment, the target frame may be a photo with highest charity in the photo frame sequence. In an embodiment, the charity of the photo may be represented with at least one of the following parameters: a resolution, and a detection operator. The detection operator may include, but is not limited to: a laplace operator, a teneegrad operator, and an energy gradient function. The frame selection module may detect the charity of the photo based on the at least one parameter.

For example, the resolution is used as an example. The frame selection module may take a photo with highest charity in the photo frame sequence as the photo with the highest charity, and take the photo with the highest charity as the target frame.

In an embodiment, the frame selection module may select the target frame from the photo frame sequence based on a shooting parameter of each photo in the photo frame sequence. For example, the frame selection module may take a photo with a largest focus value in the photo frame sequence as the target frame. Alternatively, the frame selection module may take a photo with largest photosensitivity ISO as the target frame.

For example, the photo frame sequence includes eight frames of photos, and the frame selection module may select a photo with highest charity from the eight frames of photos, and take the photo with the highest charity as the target frame.

S609: The frame selection module sends the target frame to a thumbnail processing module.

S610: The thumbnail processing module processes the target frame, to obtain a first thumbnail.

The target frame is a RAW image. The thumbnail processing module may convert the target frame to a YUV format, and convert the target frame in the YUV format to an RGB format, to obtain the first thumbnail.

In an embodiment, a size of the first thumbnail may be different from a size of the target frame. The thumbnail processing module may further change the size of the target frame in the RGB format, to obtain a first thumbnail with a preset size.

S611: The thumbnail processing module sends the first thumbnail to an image processing module.

S612: The image processing module stores the first thumbnail.

It should be understood that generation of the first thumbnail is performed when the user presses the shooting control but does not lift the hand.

S613: If determining that the user presses the shooting control and lifts the hand, the camera application sends a second event to a shooting decision-making module in response to the touch information.

When the camera application determines that the user presses the shooting control, S605 to S612 may be performed. In a process in which S605 to S612 are performed, the touch IC continuously obtains the touch information, and reports the touch information to the camera application via the touch driver. The touch information indicates an operation of the user to operate on a screen of the terminal.

If the camera application determines that the user presses the shooting control and lifts the hand, the camera application sends the second event to the shooting decision-making module in response to the touch information. In an embodiment, the second event may be referred to as a clickup event. The second event is used to trigger the terminal to display the first thumbnail.

S614: The shooting decision-making module sends a thumbnail feedback indication to the image processing module.

In an embodiment, if determining that the user presses the shooting control and lifts the hand, the camera application may directly send the thumbnail feedback indication to the image processing module in response to the touch information, to enable the image processing module to perform S615.

S615: The image processing module feeds back the first thumbnail to the camera application.

S616: The camera application displays the first thumbnail in a thumbnail display region.

For the terminal, when the user presses the shooting control in a shooting interface but does not lift the hand, the terminal may generate the first thumbnail. When the user lifts the hand, the terminal displays the first thumbnail in the thumbnail display region of the shooting interface.

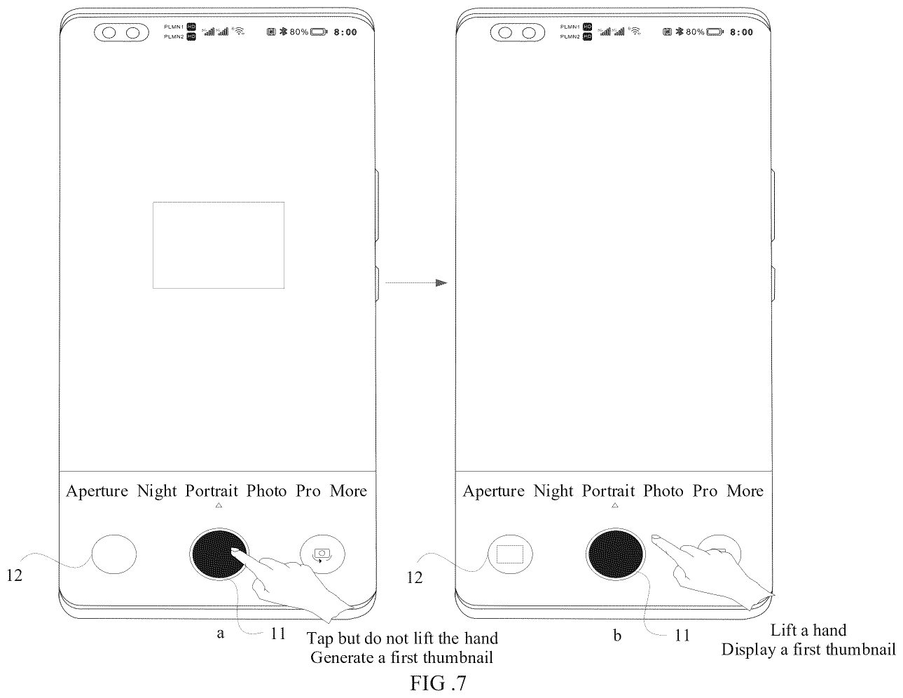

Refer to A and B in FIG. 7. When the user presses the shooting control 11, the terminal may perform S601 to S612, to generate the first thumbnail. When the user lifts the hand, the terminal may perform S613 to S616, to display the first thumbnail. In comparison with a procedure in FIG. 3, the user needs to perform an operation of generating the first thumbnail and the operation of displaying the first thumbnail when lifting the hand in FIG. 3. Therefore, long duration is taken. In this embodiment of this application, the operation of generating the first thumbnail is shifted before the operations that “the user presses the shooting control 11 and the user lifts the hand”. Therefore, only the operation of displaying the first thumbnail needs to be performed when the user lifts the hand, without performing, with long duration, an operation of generating the first thumbnail. This reduces the duration taken from a time at which the user taps the shooting control 11 to the time at which the first thumbnail is displayed, to enable the user to quickly view the first thumbnail, and improve a shooting speed of the terminal.

Because it takes at least 100 ms from the time for the user to press the shooting control 11 to the time for the user to lift the hand, and because the operation of generating the first thumbnail is shifted forward, the first thumbnail is directly displayed when the user lifts the hand. In this embodiment of this application, the duration taken from the time at which the user taps the shooting control 11 to the time at which the thumbnail is displayed is approximately 200 ms. In comparison with the manner in FIG. 3, the duration taken from the time at which the user taps the shooting control 11 to the time at which the thumbnail is displayed is reduced, and performance of shot2see of the terminal is improved.

In an embodiment, after receiving the first thumbnail from the image processing module, the camera application may further store the first thumbnail in a gallery application.

In an embodiment, some of the steps shown in FIG. 6A and FIG. 6B are optional and the steps may be combined with each other. In an embodiment, the modules shown in FIG. 6A and FIG. 6B may also be combined, and the combined modules are used to perform at least one of the steps in FIG. 6A and FIG. 6B.

In an embodiment of this application, an operation of generating the thumbnail can be performed when the user presses the shooting control, and the thumbnail is directly displayed when the user lifts the hand. In this embodiment of this application, the operation of generating the thumbnail is shifted before the operations that “the user presses the shooting control 11 and the user lifts the hand”. Therefore, only the operation of displaying the thumbnail needs to be performed when the user lifts the hand, without performing, with the long duration, the operation of generating the thumbnail. This reduces the duration taken from the time at which the user taps the shooting control to the time at which the thumbnail is displayed, to improve the performance of shot2see of the terminal, and enable the user to perceive that the shooting speed of the terminal is fast.

In an embodiment, when (or after) the image processing module receives the first thumbnail from the thumbnail processing module or when the image processing module receives the thumbnail feedback indication from the shooting decision-making module, the image processing module may further perform S617 to S621.

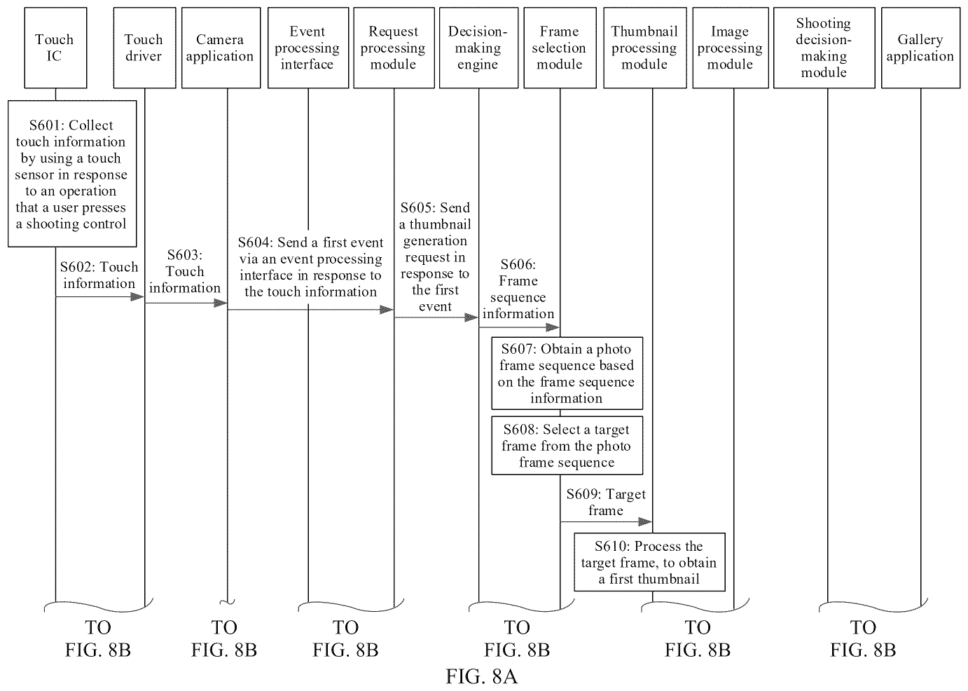

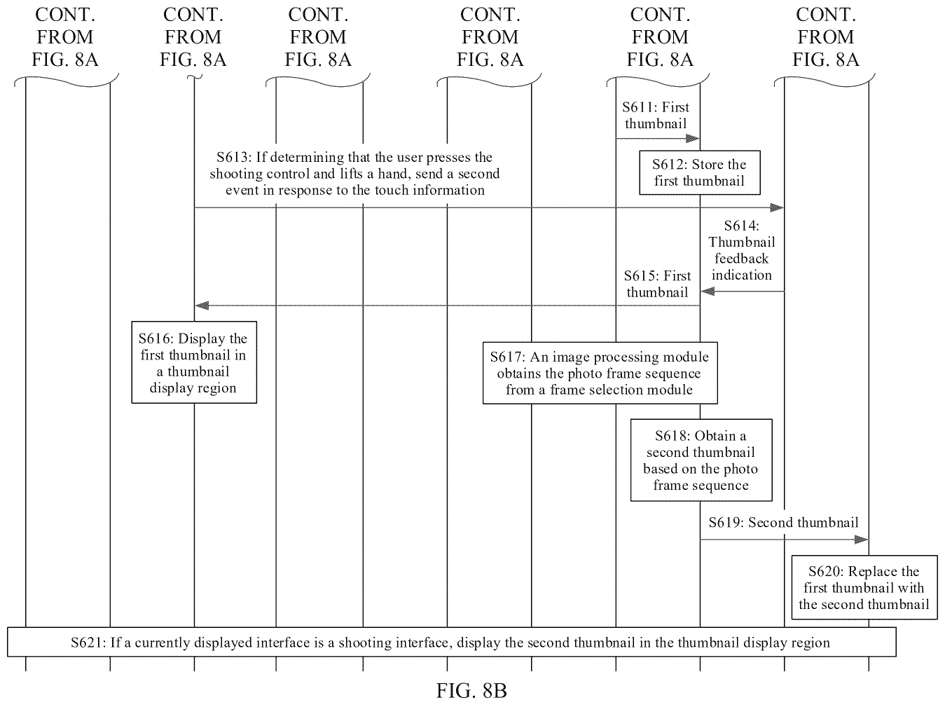

An example in which S617 to S621 are performed after S614 in FIG. 8A and FIG. 8B is used for description. It should be understood that S617 to S621 and S615 to S616 may be performed simultaneously.

S617: The image processing module obtains the photo frame sequence from the frame selection module.

The frame selection module may obtain the photo frame sequence, and the image processing module may obtain the photo frame sequence from the frame selection module. For example, the image processing module may send a request for the photo frame sequence to the frame selection module in response to the thumbnail feedback indication, to indicate the frame selection module to feed back the photo frame sequence. Accordingly, the frame selection module may feed back the photo frame sequence to the image processing module in response to the photo frame sequence request.

S618: The image processing module obtains a second thumbnail based on the photo frame sequence.

In an embodiment, the second thumbnail may be obtained after being processed by the photo frame sequence.

In an embodiment, the image processing module may fuse photos in the photo frame sequence, to obtain a fused photo frame. For example, the image processing module may compare the charity of regions in the photos in the photo frame sequence (for example, the eight frames of photos), and fuse regions with highest charity, to obtain the fused photo frame. The fused photo frame is a RAW image.

The image processing module may convert the fused photo frame to a YUV format, and convert the fused photo frame in the YUV format to an RGB format, to obtain the second thumbnail.

S619: The image processing module feeds back the second thumbnail to the gallery application.

S620: The gallery application replaces the first thumbnail with the second thumbnail.

S621: If a currently displayed interface is the shooting interface, display the second thumbnail in the thumbnail display region.

In an embodiment, some of the steps shown in FIG. 8A and FIG. 8B are optional and the steps may be combined with each other. In an embodiment, the modules shown in FIG. 8A and FIG. 8B may also be combined, and the combined modules are used to perform at least one of the steps in FIG. 8A and FIG. 8B.

In this embodiment of this application, on the basis of the user perceiving that the shooting speed of the terminal is fast, photo frame sequences may be fused, to obtain a RAW image, and the second thumbnail may be generated based on the RAW image, to display the second thumbnail in the thumbnail display region. In an embodiment, charity of the second thumbnail is higher than charity of the first thumbnail, so that the user can view a clearer thumbnail in the thumbnail display region.

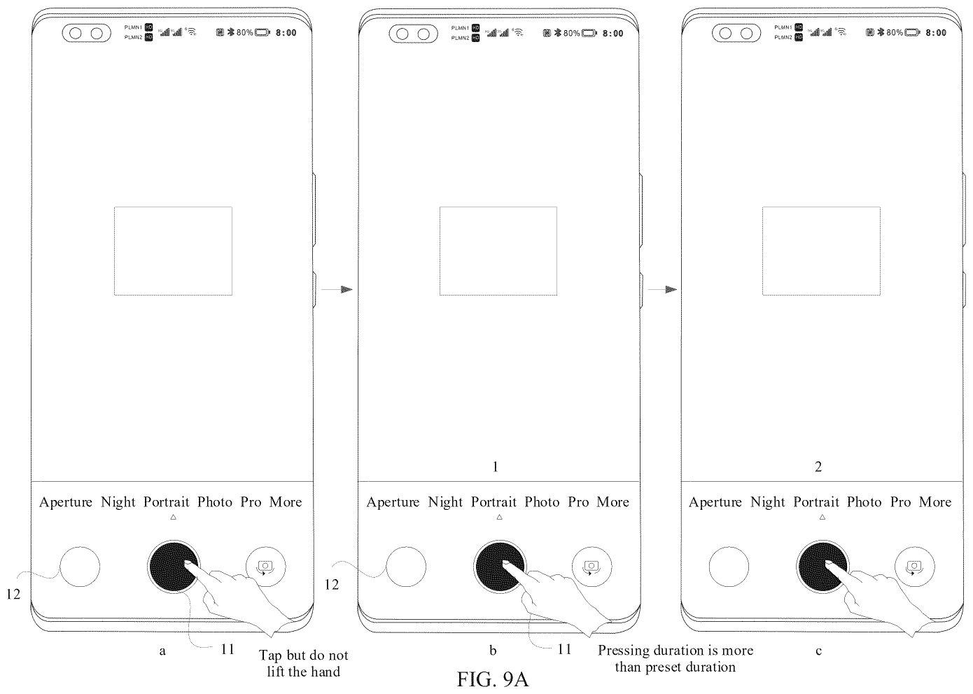

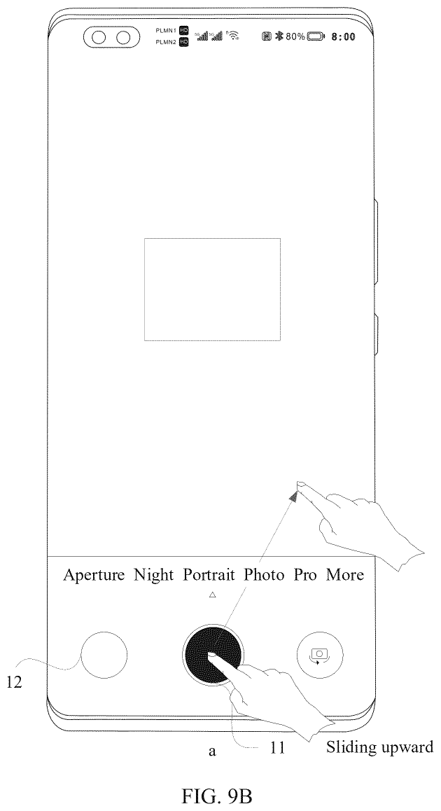

Refer to FIG. 7. If the user taps the shooting control (including the operation of pressing and the operation of lifting the hand), the terminal can be triggered to quickly display the thumbnail. In an embodiment, the user may also operate the shooting control in other manners. Refer to A to C in FIG. 9A. When the user presses the shooting control and pressing duration is more than preset duration, the terminal may be triggered to perform continuous shooting (that is, continuously take a plurality of photos). Refer FIG. 9B. Alternatively, the user may accidentally touch (press) the shooting control in a sliding process. Sliding may be understood that the user performs a sliding (for example, sliding upward or downward) operation on the screen.

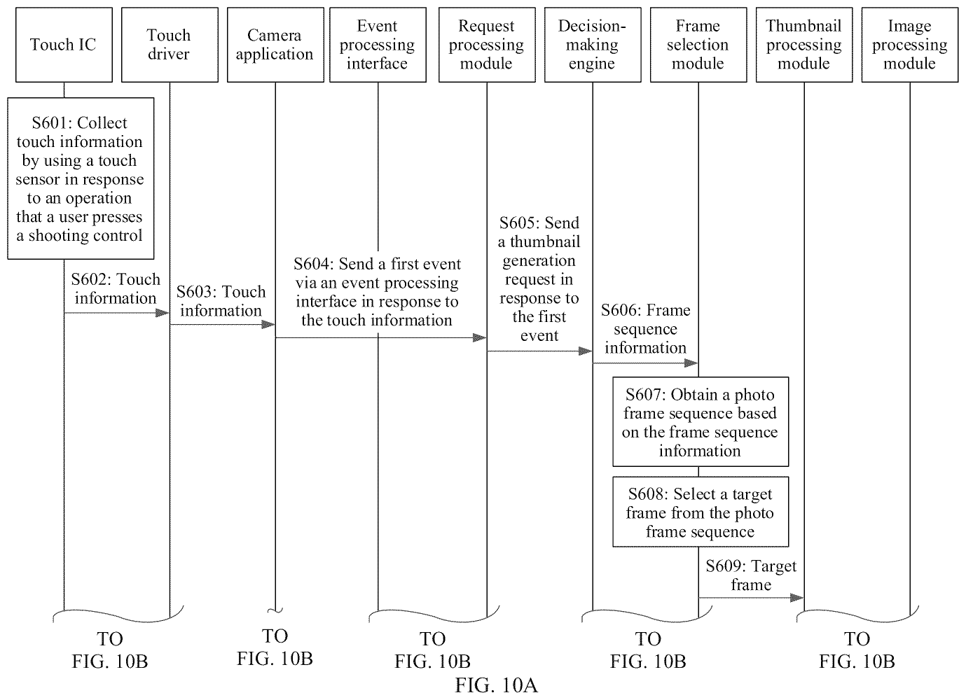

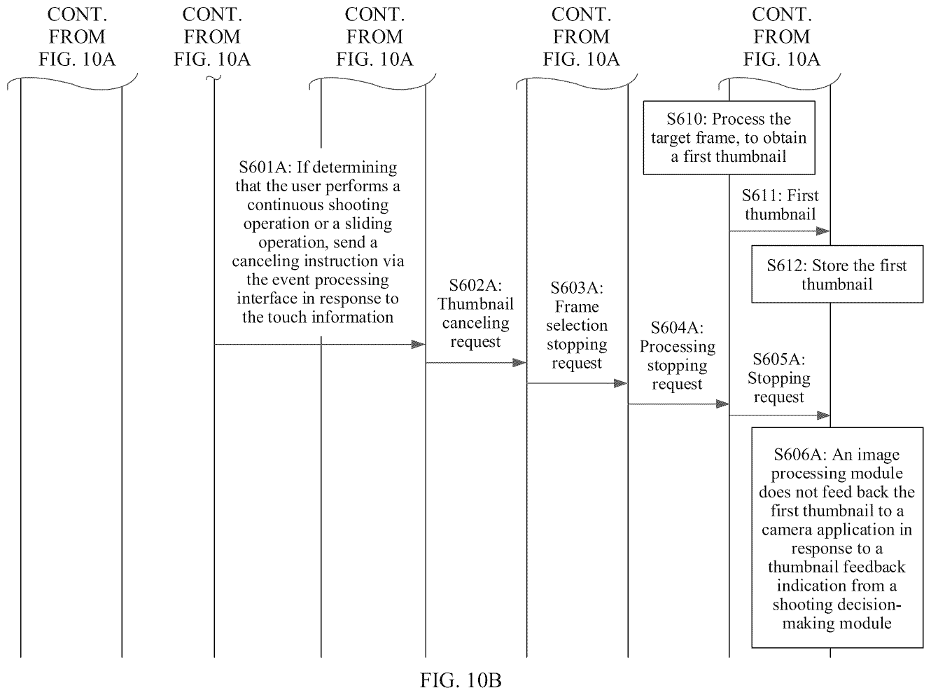

As shown in FIG. 9A and FIG. 9B, regardless of the continuous shooting operation or the sliding operation, the user presses the shooting control, to trigger the terminal to perform S601 to S612. Refer to FIG. 10A and FIG. 10B. In a process in which the terminal performs S601 to S612 (an example in which the terminal performs S601 to S612 in FIG. 10A and FIG. 10B is used for description), the terminal may further perform S601A to S606A.

S601A: If determining that the user performs the continuous shooting operation or the sliding operation, the camera application sends a canceling instruction to the request processing module via the event processing interface in response to the touch information.

Because the touch IC continuously obtains the touch information, and reports the touch information to the camera application via the touch driver, the camera application may detect an operation of the user based on the touch information. If detecting that the user performs the continuous shooting operation or the sliding operation, the camera application may send the canceling instruction to the request processing module via the event processing interface based on the touch information. The canceling instruction indicates to cancel generation of the thumbnail. Correspondingly, the camera application may trigger the terminal to perform the continuous shooting operation or an operation in response to the sliding operation. In an embodiment, the canceling instruction may be referred to as a command to cancel capturing of cancelCapture.

In an embodiment, the touch information may include a touch position. The camera application may detect the operation of the user based on the touch information that is continuously reported by the touch IC. If determining that duration that the user taps the shooting control is more than the preset duration, the camera application may determine that the user performs the continuous shooting operation. If determining that the user continuously taps another position on the screen after tapping the shooting control, the camera application may determine, based on the touch information, that the user performs the sliding operation.

S602A: The request processing module sends a thumbnail canceling request to the decision-making engine.

The thumbnail canceling request indicates to stop generating the thumbnail.

In an embodiment, when the decision-making engine receives the thumbnail canceling request from the request processing module, if the decision-making engine does not send the frame sequence information to the frame selection module, the decision-making engine may stop sending the frame sequence information to the frame selection module. When the decision-making engine receives the thumbnail canceling request from the request processing module, if the decision-making engine has sent the frame sequence information to the frame selection module, the decision-making engine may perform S603A.

S603A: The decision-making engine sends a frame selection stopping request to the frame selection module.

The frame selection stopping request indicates the frame selection module to stop frame selection.

In an embodiment, when the frame selection module receives the frame selection stopping request from the decision-making engine, if the frame selection module is selecting the target frame from the photo frame sequence, the frame selection module may stop performing the frame selection operation (that is, stop selecting the target frame). When the frame selection module receives the frame selection stopping request from the decision-making engine, if the frame selection module has selected the target frame but does not send the target frame to the thumbnail processing module, the frame selection module may stop sending the target frame to the thumbnail processing module. When the frame selection module receives the frame selection stopping request from the decision-making engine, if the frame selection module has sent the target frame to the thumbnail processing module, the frame selection module may perform S604A.

S604A: The frame selection module sends a processing stopping request to the thumbnail processing module.

The processing stopping request indicates the thumbnail processing module to stop generating the thumbnail.

In an embodiment, when the thumbnail processing module receives the processing stopping request from the frame selection module, if the thumbnail processing module is generating the thumbnail based on the target frame, the thumbnail processing module may stop processing the target frame. When the thumbnail processing module receives the processing stopping request from the frame selection module, if the thumbnail processing module has generated the thumbnail based on the target frame but does not send the thumbnail to the image processing module, the thumbnail processing module may stop sending the thumbnail to the image processing module. When the thumbnail processing module receives the processing stopping request from the frame selection module, if the thumbnail processing module has sent the thumbnail to the image processing module, the thumbnail processing module may perform S605A.

S605A: The thumbnail processing module sends a stopping request to the image processing module.

The stopping request indicates the image processing module to stop feeding back the thumbnail to the camera application.

S606A: The image processing module does not feed back the thumbnail to the camera application in response to the thumbnail feedback indication from the shooting decision-making module.

In this embodiment of this application, the user performs the continuous shooting operation or the sliding operation, not triggering shooting and displaying the thumbnail. Therefore, on the premise of receiving the stopping request, when the image processing module receives the thumbnail feedback indication from the shooting decision-making module, the image processing module does not feed back the thumbnail to the camera application.

In this embodiment of this application, the thumbnail may be generated when the user presses the shooting control. However, if it is determined, based on the touch information, that the operation of the user is the continuous shooting operation or the sliding operation, in the process of generating the thumbnail, the operation of generating the thumbnail may be canceled, to trigger the terminal to perform the continuous shooting operation or perform the operation in response to the sliding operation, to implement an accurate response.

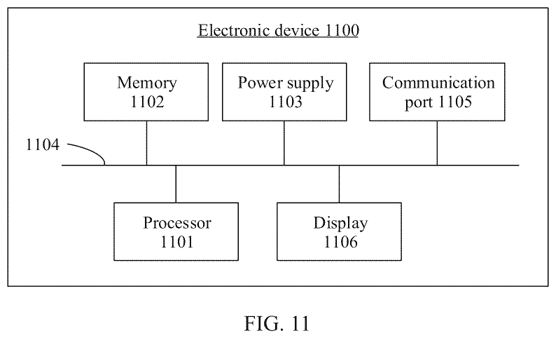

Refer to FIG. 11. In an embodiment, an embodiment of this application further provides an electronic device. The electronic device may be the terminal in the foregoing embodiments. The electronic device 1100 may include: a processor 1101 (for example, a central processing unit (CPU)) and a memory 1102. The memory 1102 may include a high-speed random-access memory (RAM), or may further include a non-volatile memory (NVM), for example, at least one magnetic disk memory. The memory 1102 may store various instructions, which are configured to implement various processing functions and implement method steps of this application.

Optionally, the electronic device 1100 in this application may further include a power supply 1103, a communication bus 1104, and a communication port 1105. The foregoing communication port 1105 is configured to implement connection and communication between the electronic device 1100 and another peripheral. In this embodiment of this application, the memory 1102 is configured to store computer-executable program code. The program code includes instructions. When the processor 1101 executes the instructions, the instructions enable the processor 1101 of the electronic device 1100 to perform actions in the foregoing method embodiments. An implementation principle and technical effects are similar to those in the foregoing method embodiments. Details are not described herein again.

In an embodiment, the electronic device 1100 may include a display 1106. The display 1106 is configured to display an interface of the electronic device 1100. In an embodiment, the display 1106 may also be referred to as a screen.

It should be noted that the modules or components in the foregoing embodiments may be one or more integrated circuits configured to implement the foregoing method, for example, one or more application specific integrated circuits (ASICs), one or more microprocessors (e.g., digital signal processors (DSPs)), or one or more field programmable gate arrays (FPGAs). For another example, when a module described above is implemented in a form of scheduling program code by a processing element, the processing element may be a general-purpose processor, for example, a central processing unit (CPU), or another processor that may call the program code, such as a controller. For another example, such modules may be integrated together and implemented in a form of a system-on-a-chip (SOC).

All or some of the foregoing embodiments may be implemented by using software, hardware, firmware, or any combination thereof. When the software is used for implementation, all or some of the embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, that includes an integration of one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

The term “a plurality of” in this specification means two or more than two. In this specification, the term “and/or” is merely used to describe an association relationship between associated objects, and indicates that three relationships may exist. For example, “A and/or B” may indicate the following three cases: Only A exists, both A and B exist, and only B exists. In addition, the character “/” in this specification usually indicates an “or” relationship between associated objects. In a formula, the character “/” indicates that the associated objects are in a “division” relationship. In addition, it should be understood that in descriptions of this application, terms such as “first” and “second” are merely used for distinguishing descriptions, and should not be understood as an indication or implication of relative importance or as an indication or implication of an order.

It may be understood that, various reference numerals in embodiments of this application are merely for differentiation for ease of description, and are not intended to limit the scope of embodiments of this application.

It may be understood that, in embodiments of this application, an order of sequence numbers of the foregoing processes does not indicate an execution sequence, and execution sequences of the processes should be determined according to functions and internal logics thereof and should not impose any limitation on an implementation process of embodiments of this application.

1.-12. (canceled)

13. A method for displaying a thumbnail during shooting, applied to an electronic device, wherein the electronic device comprises a touch sensor that collects touch information, and wherein the method comprises:
displaying a shooting interface in response to a first operation of a user, wherein the shooting interface displays a shooting control and a thumbnail display region;
in response to first touch information, determining that the user presses the shooting control, and generating a first thumbnail;
in response to second touch information, determining that the user lifts a hand after pressing the shooting control, and displaying the first thumbnail in the thumbnail display region; and
in response to third touch information, determining that the user performs a continuous shooting operation or a sliding operation, and canceling generating the first thumbnail;
wherein the third touch information comprises that the user contacts the shooting control for a duration is longer than a preset duration or the user continuously touches another location on a screen other than the shooting control after contacting the shooting control.

14. The method according to claim 13, wherein the first thumbnail is generated based on a target frame, and the target frame is a photo with a highest clarity in a photo frame sequence.

15. The method according to claim 14, wherein the target frame is determined based on a shooting parameter of each photo in the photo frame sequence, and the shooting parameter comprises a focus value and photosensitivity.

16. The method according to claim 13, wherein before the displaying the first thumbnail in the thumbnail display region, the method further comprises:
generating a second thumbnail; and
replacing the first thumbnail with the second thumbnail;
wherein the displaying the first thumbnail in the thumbnail display region comprises:
displaying the second thumbnail in the thumbnail display region.

17. The method according to claim 15, wherein before the displaying the first thumbnail in the thumbnail display region, the method further comprises:
generating a second thumbnail; and
replacing the first thumbnail with the second thumbnail;
wherein the displaying the first thumbnail in the thumbnail display region comprises:
displaying the second thumbnail in the thumbnail display region.

18. The method according to claim 16, wherein the second thumbnail is obtained based on fusion of highest clarity regions of each photo in the photo frame sequence, and a clarity of the second thumbnail is higher than a clarity of the first thumbnail.

19. The method according to claim 17, wherein the second thumbnail is obtained based on fusion of highest clarity regions of each photo in the photo frame sequence, and a clarity of the second thumbnail is higher than a clarity of the first thumbnail.

20. The method according to claim 13, wherein the electronic device comprises a memory storing a camera application a processor, and wherein the generating the first thumbnail comprises:
controlling, by the camera application, the processor to generate the first thumbnail; and
feeding back, by the processor, the first thumbnail to the camera application;
wherein the displaying the first thumbnail in the thumbnail display region comprises:
controlling, by the camera application, the electronic device to display the first thumbnail in the thumbnail display region.

21. The method according to claim 17, wherein the electronic device comprises a memory storing a camera application and a processor, wherein the generating the first thumbnail comprises:
controlling, by the camera application, the processor to generate the first thumbnail; and
feeding back, by the processor, the first thumbnail to the camera application; and
wherein the displaying the first thumbnail in the thumbnail display region comprises:
controlling, by the camera application, the electronic device to display the first thumbnail in the thumbnail display region.

22. The method according to claim 19, wherein the electronic device comprises a memory storing a camera application and a processor, wherein the generating the first thumbnail comprises:
controlling, by the camera application, the processor to generate the first thumbnail; and
feeding back, by the processor, the first thumbnail to the camera application; and
wherein the displaying the first thumbnail in the thumbnail display region comprises:
controlling, by the camera application, the electronic device to display the first thumbnail in the thumbnail display region.

23. The method according to claim 20, wherein the controlling, by the camera application, the processor to generate the first thumbnail comprises:
sending, by the camera application, a first event to the processor, wherein the first event indicates to generate the thumbnail;
obtaining, by the processor, the photo frame sequence based on frame sequence information, wherein the photo frame sequence comprises at least two photos;
selecting, by the processor, a target frame from the photo frame sequence;
generating, by the processor, the first thumbnail based on the target frame.

24. The method according to claim 22, wherein the controlling, by the camera application, the processor to generate the first thumbnail comprises:
sending, by the camera application, a first event to the processor, wherein the first event indicates to generate the thumbnail;
obtaining, by the processor, the photo frame sequence based on frame sequence information, wherein the photo frame sequence comprises at least two photos;
selecting, by the processor, a target frame from the photo frame sequence;
generating, by the processor, the first thumbnail based on the target frame.

25. The method according to claim 23, wherein the feeding back, by the processor, the first thumbnail to the camera application comprises:
sending, by the camera application, a second event to the processor, wherein the second event indicates to display the first thumbnail; and
feeding back, by the processor, the first thumbnail to the camera application in response to the second event.

26. The method according to claim 25, wherein the method further comprises:
based on an operation performed by the user in the shooting interface being a continuous shooting operation or a sliding operation, sending, by the camera application, a canceling instruction to the processor, wherein the canceling instruction indicates to cancel generation of the first thumbnail; and
based on the processor receiving the canceling instruction, not feeding back, by the processor, the first thumbnail to the camera application.

27. The method according to claim 23, wherein the electronic device further comprises a gallery application stored in the memory, and after the feeding back, by the processor, the first thumbnail to the camera application, the method further comprises:
sending, by the camera application, the first thumbnail to the gallery application;
storing, by the gallery application, the first thumbnail;
generating, by the processor, the second thumbnail based on the photo frame sequence;
sending, by the processor, the second thumbnail to the gallery application; and
replacing, by the gallery application, the first thumbnail with the second thumbnail.

28. The method according to claim 26, wherein the electronic device further comprises a gallery application stored in the memory, and after the feeding back, by the processor, the first thumbnail to the camera application, the method further comprises:
sending, by the camera application, the first thumbnail to the gallery application;
storing, by the gallery application, the first thumbnail;
generating, by the processor, the second thumbnail based on the photo frame sequence;
sending, by the processor, the second thumbnail to the gallery application; and
replacing, by the gallery application, the first thumbnail with the second thumbnail.

29. The method according to claim 27, wherein after the replacing, by the gallery application, the first thumbnail with the second thumbnail, the method further comprises:
when the electronic device displays the shooting interface, obtaining, by the camera application, the second thumbnail from the gallery application; and
controlling, by the camera application, the electronic device to display the second thumbnail in the thumbnail display region.

30. The method according to claim 23, wherein the electronic device further comprises an event processing interface, and the sending, by the camera application, the first event to the processor comprises:
sending, by the camera application, the first event to the processor via the event processing interface.

31. An electronic device, comprising:
a memory that stores computer instructions; and
a processor that executes the computer instructions stored in the memory, to enable the processor to perform operations comprising:
displaying a shooting interface in response to a first operation of a user, wherein the shooting interface displays a shooting control and a thumbnail display region;
in response to first touch information, determining that the user presses the shooting control, and generating a first thumbnail;
in response to second touch information, determining that the user lifts a hand after pressing the shooting control, and displaying the first thumbnail in the thumbnail display region; and
in response to third touch information, determining that the user performs a continuous shooting operation or a sliding operation, and canceling generating the first thumbnail;
wherein the third touch information comprises that the user contacts the shooting control for a duration that is longer than a preset duration or the user continuously touches another location on a screen other than the shooting control after contacting the shooting control.

32. A non-transitory computer-readable storage medium, wherein the computer-readable storage medium stores a computer program or instructions, and when the computer program or the instructions are executed by a processor, a computing device is configured to perform operations comprising:
displaying a shooting interface in response to a first operation of a user, wherein the shooting interface displays a shooting control and a thumbnail display region;
in response to first touch information, determining that the user presses the shooting control, and generating a first thumbnail;
in response to second touch information, determining that the user lifts a hand after pressing the shooting control, and displaying the first thumbnail in the thumbnail display region; and
in response to third touch information, determining that the user performs a continuous shooting operation or a sliding operation, and canceling generating the first thumbnail;
wherein the third touch information comprises that the user contacts the shooting control for a duration that is longer than a preset duration or the user continuously touches another location on a screen other than the shooting control after contacting the shooting control.
